(19) United States
(12) Patent Application Publication
(10) Pub. No.: US 2024/0188641 A1
(43) Pub. Date: Jun. 13, 2024

(54) METHOD OF SELECTING A HEATER POWER SETTING IN AN AEROSOL PROVISION SYSTEM

(71) Applicant: Nicoventures Trading Limited, LONDON (GB)

(72) Inventors: Robert KERSEY, Brighton (GB); Darryl BAKER, London (GB); Joseph Peter SUTTON, London (GB); Sally BELL, London (GB); Chris YIN, Shenzhen (CN); Nejat ERGUVEN, London (GB)

(21) Appl. No.: 18/554,520

(22) PCT Filed: Apr. 8, 2022
(86) PCT No.: PCT/GB2022/050896

§ 371 Date: Oct. 9, 2023

(30) Foreign Application Priority Data
Apr. 9, 2021 (GB) 2105120.6
Apr. 12, 2021 (GB) 2105202.2

(51) Int. Cl. A24F 40/57; A24F 40/65; H04W 4/80

(52) U.S. Cl. CPC A24F 40/57; A24F 40/65; H04W 4/80

(57) ABSTRACT

There is provided a method of selecting a heater power setting for a non-combustible aerosol provision system. The method includes receiving user input at a user device indicative of a heater power setting, and transmitting, by the user device to the non-combustible aerosol provision system, an indication of the heater power setting. The method then includes setting, by the non-combustible aerosol provision system, a power level of the heater to the indicated heater power setting.

### PRIORITY CLAIM

The present application is a National Phase entry of PCT Application No. PCT/GB2022/050896, filed Apr. 8, 2022, which claims priority from GB Application Nos. 2105120.6 and 2105202.2, filed Apr. 9, 2021, and Apr. 12, 2021, each of which hereby fully incorporated herein by reference.

### TECHNICAL FIELD

The present disclosure relates to the field of controlling an aerosol provision system. In particular, but not exclusively, the present disclosure relates to selecting a heater power setting for an aerosol provision system.

### BACKGROUND

A “non-combustible” aerosol provision system is an aerosol provision system where a constituent aerosol-generating material of the aerosol provision system (or component thereof) is not combusted or burned in order to facilitate delivery of at least one substance to a user.

The non-combustible aerosol provision system may be an electronic cigarette, also known as a vaping device or electronic nicotine delivery system (END), although it is noted that the presence of nicotine in the aerosol-generating material is not a requirement.

The non-combustible aerosol provision system may be an aerosol-generating material heating system, also known as a heat-not-burn system. An example of such a system is a tobacco heating system.

The non-combustible aerosol provision system may be a hybrid system to generate aerosol using a combination of aerosol-generating materials, one or a plurality of which may be heated. Each of the aerosol-generating materials may be, for example, in the form of a solid, liquid or gel and may or may not contain nicotine. The hybrid system may comprise a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

The non-combustible aerosol provision system, such as a non-combustible aerosol provision device thereof, may comprise a power source and a controller. The power source may, for example, be an electric power source or an exothermic power source. The exothermic power source comprises a carbon substrate which may be energized so as to distribute power in the form of heat to an aerosol-generating material or to a heat transfer material in proximity to the exothermic power source.

The non-combustible aerosol provision system may comprise an area for receiving the consumable, an aerosol generator, an aerosol generation area, a housing, a mouthpiece, a filter and/or an aerosol-modifying agent.

The consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Known approaches are described in WO2018/087719A1, US2015/075546A1, WO2017/218982A1, WO2015/192084A1, and US2017/086505A1.

### SUMMARY

Viewed from a first aspect, there is provided a method of selecting a heater power setting for a non-combustible aerosol provision system comprising: receiving user input at a user device indicative of a heater power setting; transmitting, by the user device to the non-combustible aerosol provision system, an indication of the heater power setting; and setting, by the non-combustible aerosol provision system, a power level of the heater to the indicated heater power setting. Thus an efficient and effective approach is provided for managing consumption of battery power of a non-combustible aerosol provision system.

Viewed from a second aspect, there is provided a system for selecting a heater power setting for a non-combustible aerosol provision system comprising: the non-combustible aerosol provision system; and a user device configured to receive user input indicative of a heater power setting, and transmit to the non-combustible aerosol provision system, an indication of the heater power setting; wherein the non-combustible aerosol provision system comprises a heater and the non-combustible aerosol provision system is configured to set a power level of the heater to the indicated heater power setting. Thus an efficient and effective approach is provided for resource management for a non-combustible aerosol provision system

Viewed from a third aspect, there is provided a computer-readable medium comprising instructions which, when executed by processing circuitry of a computing device, cause the computing device to: receive user input indicative of a heater power setting; and transmit, to a non-combustible aerosol provision system, an indication of the heater power setting; wherein transmitting the indication of the heater power setting causes the non-combustible aerosol provision system to set a power level of a heater to the indicated heater power setting.

### BRIEF DESCRIPTION OF FIGURES

Embodiments and examples of the present approaches will now be described, by way of example only, with reference to the accompanying drawings, in which:

FIG. 1 is a schematic illustrating an example of a non-combustible aerosol provision system.

FIG. 2 is a schematic illustrating an example of a user device.

FIG. 3 is a flowchart illustrating a method of selecting a heater power setting for a non-combustible aerosol provision system.

FIG. 4 is a schematic illustrating a user interface for selecting a heater power setting for a non-combustible aerosol provision system.

While the presently described approach is susceptible to various modifications and alternative forms, specific embodiments are shown by way of example in the drawings and are herein described in detail. It should be understood, however, that drawings and detailed description thereto are not intended to limit the scope to the particular form disclosed, but on the contrary, the scope is to cover all modifications, equivalents and alternatives falling within the spirit and scope as defined by the appended claims.

### DETAILED DESCRIPTION

Non-combustible aerosol provision systems typically comprise a heater to subject aerosol-generating material to heat energy, so as to release one or more volatiles from the aerosol-generating material to form an aerosol.

By varying the power applied to the heater of the non-combustible aerosol provision system, the properties of the aerosols generated by the non-combustible aerosol provision system can be controlled. For example, by providing more power to the heater, a larger volume of aerosol can be produced by the non-combustible aerosol provision system for a given aerosol generation activation than if lower power were supplied. The volume of aerosol created by an aerosol generation activation may be termed a cloud, and thus it may be termed that a changed heater power may lead to a changed size of the cloud.

In accordance with the techniques described herein, there is provided an approach by which a user can vary the power supplied to the heater when the non-combustible aerosol provision system is used to generate aerosols. This in turn allows the user to control the properties of the aerosols produced, e.g., to create a larger/smaller cloud, more intense experience etc.

By providing a mechanism to control the heater power setting of the non-combustible aerosol provision system in this way, the present techniques provide a high level of control over the properties of the aerosols produced. This can be useful for example, to compensate for the potentially different properties of aerosolizable materials (also termed aerosol medium) used with the non-combustible aerosol provision system. That is, where variation in the materials being aerosolized causes different behavior upon heating, by adjusting the heater setting accordingly, the user can control the properties of the aerosols produced to counteract the variation in such materials.

The heater power setting may also be used to control the experience of using the non-combustible aerosol provision system according to a user's preference by generating aerosols having the user's desired properties. Further, since the rate at a power supply of the non-combustible aerosol provision system (e.g., a battery) and a supply of aerosolizable material is depleted may be linked to the power supplied to the heater, controlling the heater power setting can also be used to affect (e.g., slow down) the rate at which the battery/supply of material is used up.

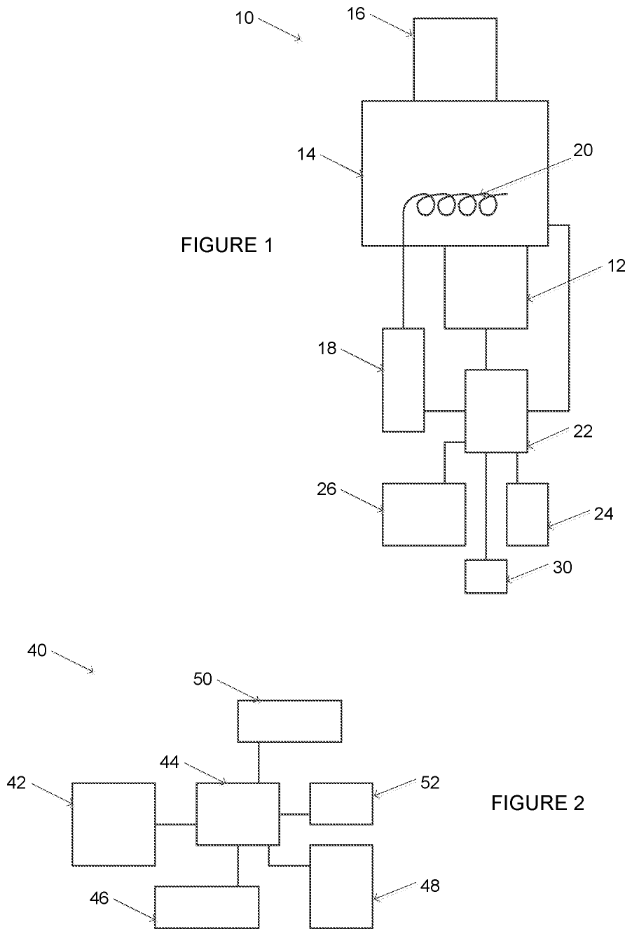

It will be appreciated that the present approaches involve transmission of data to and from a non-combustible aerosol provision system, and for the non-combustible aerosol provision system to process stored and/or received data. Also, the present approaches require a user device to be capable of communicating with a non-combustible aerosol provision system. Such a user device may be capable of communicating with other services or systems. Therefore, to illustrate suitable devices for providing such functionalities, an example non-combustible aerosol provision system 10 and an example user device 40 are illustrated with respect to FIGS. 1 and 2 respectively.

An example of a non-combustible aerosol provision system 10 is schematically illustrated in FIG. 1. As shown, the aerosol delivery device 10 is a device which contains elements relating to aerosol generation such as an aerosol medium container or cartridge 12 (in the case of an END device, the aerosol medium container or cartridge 12 will contain nicotine or a nicotine-bearing formulation), an aerosol generation chamber 14 and an outlet 16 through which a generated aerosol may be discharged. A battery 18 may be provided to power a thermal generator element (such as a heater 20 which may take the form of a heater coil) within (or functionally adjacent to) the aerosol generation chamber 14. The battery 18 may also power a processor/controller 22 which may serve purposes of device usage, such as activation of the device for aerosol generation in response to an activation trigger, and purposes of communication and functionality control. Processor/controller 22 may have access to a memory 24 which may be used to store operating instructions for the processor/controller 22. The memory 24 may also be used to store data describing operating conditions and/or states of the non-combustible aerosol provision system 10 and/or one or more components thereof. The memory 24 may be internal to the processor/controller 22 or may be provided as an additional separate physical element.

To perform transmission and reception of data and/or messaging, the processor/controller 22 is provided with a transmitter/receiver element 26. The transmitter/receiver element 26 enables the non-combustible aerosol provision system 10 to communicate with a connected device using a connectivity technology such as a personal area network protocol. Example personal area network protocols include Bluetooth™, Bluetooth Low Energy™ (BLE), Zigbee™, Wireless USB, and Near-Field Communication (NFC). Example personal area network protocols also include protocols making use of optical communication such as Infrared Data association (IrDA), and data-over-sound. Other wireless technologies such as a Wi-Fi™ technology may be used if the non-combustible aerosol provision system has suitable capability. In other examples, the transmitter/receiver element 26 may be configured to provide for a wired communication channel provided between physical ports of the non-combustible aerosol provision system 10 and a connected device. Such a wired communication channel may utilize a physical connection technology such as USB™, a serial port, FireWire™ or other point-to-point wired connectivity. The remainder of this discussion will use the example of BLE and will use BLE terminology, although it will be appreciated that corresponding or equivalent functionalities of other personal area network technologies may be substituted. Thus, in the present example, the transmitter/receiver element 26 is a BLE interface element including or connected to a radio antenna for wireless communication. In other examples such as those indicated above this may be an interface element for an alternative wireless technology and/or a wired connection interface.

Any communication established with a connected device may be impermanent or otherwise transient in the sense that the channel may be established for a period of time necessary to carry out specific functionalities, but may also be disconnected when not required. For this reason such a connected device will be referred to herein as a user device, in the sense that the device is likely to be utilized and/or controlled by a user of the non-combustible aerosol provision system 10 and a connected device. An example of such a user device (which may also be termed a remote device, in the sense that the device is remote from the non-combustible aerosol provision system, or intermediary device, in the sense that the device is intermediate between the non-combustible aerosol provision system and the unlock/age verification services) is described below with reference to FIG. 2.

Returning to the discussion of FIG. 1, the processor/controller 22 may in one example be an STM32 microcontroller as provided by ST Microelectronics and based on the ARM™ Cortex™-M processor.

In other examples an alternative microcontroller or processor may be used, which may be based upon an ARM™ architecture, and Atom™ architecture or other low power processor technology.

Alternatively or additionally, the transmitter/receiver element 26 may in one example include an nRF BLE chip for cooperating with the processor/controller to provide BLE connectivity to the non-combustible aerosol provision system. In other examples, other communication interface chips or modules may be deployed to provide connectivity services.

As illustrated, processor/controller 22 may be connected for example to aerosol medium container or cartridge 12, aerosol generation chamber 14 and battery 18. This connection may be to an interface connection or output from ones of the components and/or may be to a sensor located at or in ones of the components. These connections may provide access by the processor to properties of the respective components. For example a battery connection may be used to control activation of the non-combustible aerosol provision system for aerosol generation.

Further functionalities of the processor/controller 22 and/or the memory 24 will be described with reference to the examples of the present approaches below.

An example of a user device 40 is schematically illustrated in FIG. 2. The user device may be a device such as a mobile telephone (cellphone) or tablet of a user (and/or owner) of the non-combustible aerosol provision system 10. As shown, the user device 40 includes a receiver transmitter element 42 for communicating with a non-combustible aerosol provision system 10. Thus the receiver transmitter element 42 will be configured to use the same connectivity and protocols, etc., as the non-combustible aerosol provision system 10 with which it is to interact in any given implementation. Accordingly, in the present examples, the receiver transmitter element 42 is a BLE interface element including or connected to a radio antenna for wireless communication. In other examples such as those indicated above this may be an interface element for an alternative wireless technology and/or a wired connection interface.

The receiver transmitter element 42 is connected to a processor or controller 44 which can receive and process the data or messaging received from the non-combustible aerosol provision system. The processor or controller 44 has access to a memory 46 which can be used to store program information and/or data. The user device 40 may include a further data transmission interface 48. This interface may provide one or more interface functionalities, for example to a wired connection such as wired local area network and/or to a wireless connection such as wireless local area network and/or cellular data services. This interface may be used for example for sending and receipt of messaging to and from various other devices, computer systems, and/or computer services as required by any particular implementation. This interface may also or alternatively be used for communications relating to other functionalities of the user device 40 which are unrelated to operation of or interaction with a non-combustible aerosol provision system.

The user device 40 also includes user interface elements including an output device 50 (which may include one or more of a display, an audio output, and a haptic output) and an input device 52 (which may include one or more of buttons, keys, touch-sensitive display elements, or a mouse/trackpad).

The user device 40 may be pre-programmed or configured to provide the functionalities according to the approaches discussed below. Additionally or alternatively, the user device may store software (e.g. in memory 46) such as an app to cause the processor or controller 44 to have those functionalities when the software is executed. Thus the user device may be a multi-purpose device that has the described functionalities when the app is executed.

Software to cause the user device to become programmed for the techniques described herein may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media such as carrier signals and transmission media. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. The term “computer-readable storage media” refers to physical storage media. Transient communication media may occur between components of a single computing system (e.g. on an internal link or bus between e.g. a memory and processor) or between separate computing systems (e.g. over a network or other inter-computing device connection), and may include transmission signals, carrier waves or the like.

Such software may be loaded directly to the user device 40 from a computer-readable medium, or may be loaded to the user device by connecting the user device to another computing device (such as a desktop computer, laptop computer or the like) and using software on the other computing device to control the loading of software to the user device.

Thus there have been described a non-combustible aerosol provision system and a user device that may interact to provide a number of additional functionalities for the non-combustible aerosol provision system to a user of the user device. Examples of such functionalities will now be described.

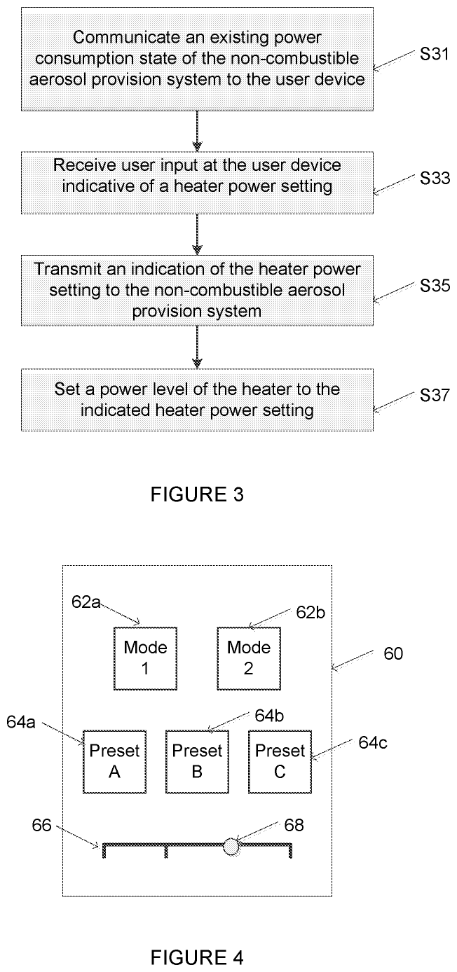

FIG. 3 is a flowchart illustrating a method of selecting a heater power setting for the non-combustible aerosol provision system 10. Shown within dotted lines is an operation that is carried out in the present example but that may not be performed in all examples of the approach.

As shown in FIG. 3, at S31 the non-combustible aerosol provision system 10 communicates to the user device 10 an existing power consumption state of the non-combustible aerosol provision system 10. In this example, the non-combustible aerosol provision system 10 is operable in a plurality of power consumption states corresponding to different profiles of power consumption and affecting the heater power settings that can be selected. Possible power consumption states include a power saving mode in which the available heater power settings that can be selected by a user are restricted to “low” heater power settings. That is, when operating the power saving mode, the non-combustible aerosol provision system 10 is configured to restrict access to heater power settings that would be otherwise be available when a power consumption state other than the power saving mode. In this way, the non-combustible aerosol provision system 10 is able to ensure that the heater power setting for the device will not be set above a certain value. Thus, the power delivered to the heater can be constrained, thereby saving power and prolonging the battery life of the device. Additionally, restricting the heater power in this way may also slow the depletion of a supply of aerosolizable material in the non-combustible aerosol provision system 10 thereby allowing the supply to last longer.

Another example of a power consumption state that may be implemented by the non-combustible aerosol provision system 10 in combination with the user device 40 is a performance mode. When operating in the performance mode, higher heater power settings may be accessible to give the user the greatest control over the heater power and consequently the properties of the aerosols generated.

The power consumption state may be selected by the user or may be automatically determined by the non-combustible aerosol provision system 10 or user device 40. For example, the non-combustible aerosol provision system 10 may be configured to automatically enter the power saving mode in response to determining that a battery level of the battery 18 is low (for example below a certain threshold) or the user may be prompted to initiate the power saving mode themself when the battery level is low.

After the power consumption state of the non-combustible aerosol provision system 10 is received by the user device 40 (if this is performed), the user provides user input to the user device 40 indicative of a heater power setting at S33. The user input is received by input device 52 (which may include one or more of buttons, keys, touch-sensitive display elements, or a mouse/trackpad as described above). An example of a user interface that may be displayed on the output device 50 of the user device 40 to invite and/or receive such input is described below with reference to FIG. 4.

The user input could take a number of possible forms. For example, the user input may comprise a value corresponding to the heater power setting. In such a case, the user device 40 may provide an input field in which a user can type a desired value (e.g., a number of watts of power or a percentage of a maximum power) for the heater power setting. Additionally, or alternatively, the user input may comprise a selection of a position on a slider, with the position corresponding to the value of the heater power setting. By allowing the user to directly select the value for the power to be applied, the user is given a high level of control over the operation of the device which may make adjustment of the device to achieve desired properties for the generated aerosols easier. Even where the user input comprises a value corresponding to the heater power setting, the user may be restricted to selection of limited number of allowable values. For example, limits on an upper and lower heater power setting may be imposed to constrain the user's selection to heater power settings supported by the non-combustible aerosol provision system 10. Additionally, the user device 40 may restrict the user's selection to values varying by a fixed increment for example. In one example, the user device 40 restricts the user's selection to values corresponding to a heater power between 2.0 W and 6.5 W in increments of 0.1 W.

However, in some examples, the user input comprises a selection of heater power setting from a plurality of preset heater power settings. The preset power settings may be preset by the user themself and stored on the user device 40 or may be common preset settings set for example by the manufacturer of the non-combustible aerosol provision system 10. This approach provides for more coarse-grained adjustment of the heater power settings and may simplify the selection of a heater power setting by the user.

Where the existing power consumption state of the device 10 was communicated at S31, the user may be restricted to selecting an available heater power setting for the existing power consumption state. The available heater power setting or settings may be selected based on the objective of the power consumption state. For example, for a power saving mode, the available heater power settings may be restricted to relatively lower heater power settings than would otherwise be available when not operating in the power saving mode.

As shown in FIG. 3, at S35, the user device 40 is configured to transmit an indication of the heater power setting selected by the user to the non-combustible aerosol provision system 10. This transmission is carried out by the receiver transmitter element 42 of the user device 40 to be received by transmitter/receiver element 26 of the non-combustible aerosol provision system 10. In this example, the transmission occurs via BLE, however, it will be appreciated that any suitable communication technology such as those mentioned above may be used.

In this example, to transmit the indication of the selected heater power setting, the user device 40 is configured to write a value representative of the power to be applied to the heater in accordance with a Bluetooth profile specification governing the BLE communication between the user device 40 and the non-combustible aerosol provision system 10. Specifically, in this example, the user device 40 is arranged to write a value in the form of an unsigned integer to the non-combustible aerosol provision system 10. The unsigned integer may take values with a certain range corresponding to lower and upper limit values of the heater power supported by the device 10. To determine the power to be applied to the heater from the value written to the device 10, the device 10 divides the value by ten. Therefore, to transmit an indication that the heater power should be set to 4.5 W, the user device 40 writes a value of 45 to the device 10 over the BLE interface.

It will be appreciated that this example provides just one illustrative example of how the heater power settings may be transmitted to the user device and other modes of communication and encoding schemes for the heater power setting may be employed.

In response to the indication of the heater power setting, at S37 the non-combustible aerosol provision system 10 is configured to set a power level of the heater to the indicated heater power setting. Thus, the non-combustible aerosol provision system 10 controls the power provided by the power source (such as the battery 18 or an exothermic power source) to the heater (e.g., heater coil 20). By adjusting the power provided to the heater in this way, the temperature to which the aerosolizable material is heated can be adjusted, thereby adjusting the properties of the aerosols produced by the non-combustible aerosol provision system 10. In this way, the user can control the cloud size/intensity of the aerosols produced by the device to achieve desired characteristics for their experience.

In contrast to an approach in which the user specifies a target temperature for the heater, by controlling the power supplied to the heater, the manufacture of the device 10 and control of the heater can be simplified. Since the power supplied by a power source (e.g., battery 18) can be controlled using power supply circuitry that is relatively easy to manufacture and control, the process of manufacturing the non-combustible aerosol provision system 10 and controlling the heater power setting can be made more efficient than an approach attempting to control a temperature of the heater. Such a temperature-based approach would likely require a temperature sensing element (such as a thermistor) and feedback control, and/or very careful calibration.

An example of a user interface screen that may be provided to a user by the output device 50 of the user device 40 to invite and/or receive such input is shown in FIG. 4.

As shown, the user interface screen 60 comprises a number of power mode indicators 62 which can be selected to adopt a specific power mode (which in turn may correspond to a power consumption state). In the present example, the indicator 62a for Mode 1 corresponds to a normal mode in which all power levels are available and the indicator 62b for Mode 2 corresponds to a power saving mode that can be engaged responsive to a power consumption state and as described above my selected by the user or may be automatically determined by the non-combustible aerosol provision system.

The user interface screen 60 also comprises a number of present indicators 64 which can be selected to adopt a specific power level preset. In the present example, the indicator 64a for Preset A corresponds to a low power level, the indicator 64b for Preset B corresponds to a medium power level, and the indicator 64c for Preset C corresponds to a high power level. In the present example, when Mode 1 (normal mode) has been selected, all of these preset modes are available for selection, but when Mode 2 (low power mode) is selected, only the low power Preset A, or the low power Preset A and the medium power Preset B are available for selection.

The user interface screen 60 also comprises a power selection slider 66, which includes a power selection control element 68 which may be selected for moving along the slider 66 to vary the power.

In the present example, when Mode 1 (normal mode) has been selected, the full range of the slider 66 is available for selection using the poser selection control element 68, whereas when Mode 2 (low power mode) is selected, only the lowest power setting or a restricted range toward the low power end of the range is available for selection using the poser selection control element 68.

In other examples, and alternative user interface approach may be used. A greater or smaller range of indicators and/or selectors may be provided, and/or the user interface elements may be split across multiple user interface screens. In some examples, there may be presented either preset indicators or a slider but not both. In some examples, there may be only one power mode and thus no indicators to enable selection between power modes. In examples in which a power mode is automatically adopted, there may be an indicator as to the active power mode, but without option to select between different power modes.

Hence, there has been described an efficient and effective approach to controlling the heater power setting of a non-combustible aerosol provision system 10 from a user device 40, thereby allowing the user to effectively adjust the properties of aerosols produced by the non-combustible aerosol provision system 10.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the disclosure as defined by the claims or limitations on equivalents to the claims, and that other embodiments may be utilized and modifications may be made without departing from the scope of the claims. Various embodiments of the disclosure may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A method of selecting a heater power setting for a non-combustible aerosol provision system comprising:
receiving user input at a user device indicative of a heater power setting;
transmitting, by the user device to the non-combustible aerosol provision system, an indication of the heater power setting; and
setting, by the non-combustible aerosol provision system, a power level of a heater to the indicated heater power setting.

2. The method according to claim 1, wherein:
the user input comprises a value corresponding to the heater power setting.

3. The method according to claim 1, wherein:
the user input comprises a selection of the heater power setting from a plurality of preset heater power settings.

4. The method according to claim 1, wherein:
the user input comprises a selection from a plurality of heater power settings, the plurality of heater power settings comprising an upper limit corresponding to a maximum selectable heater power setting, a lower limit corresponding to a minimum selectable heater power setting, and one or more intermediate heater power settings.

5. The method according to claim 4, wherein:
the selection from the plurality of heater power settings is a positioning of a power selection slider presented at the user device.

6. The method according to claim 1, wherein transmitting the indication of the heater power setting comprises writing a value representative of the heater power setting to the non-combustible aerosol provision system over a Bluetooth connection between the user device and the non-combustible aerosol provision system.

7. The method according to claim 1, further comprising:
communicating, by the non-combustible aerosol provision system, an existing power consumption state of the non-combustible aerosol provision system to the user device, wherein available heater power settings at the user device are controlled based on the existing power consumption state of the non-combustible aerosol provision system; and
receiving the user input comprises receiving a selected heater power setting of the available heater power settings.

8. The method according to claim 7, wherein:
the existing power consumption state is a power saving mode; and
the available heater power settings are restricted to one or more low heater power settings lower than a maximum heater power setting available when the existing power consumption state is a power consumption state other than the power saving mode.

9. A system for selecting a heater power setting for a non-combustible aerosol provision system comprising:
the non-combustible aerosol provision system; and
a user device configured to receive user input indicative of a heater power setting, and transmit to the non-combustible aerosol provision system an indication of the heater power setting;
wherein the non-combustible aerosol provision system comprises a heater and the non-combustible aerosol provision system is configured to set a power level of the heater to the indicated heater power setting.

10. The system according to claim 9, wherein:
the user input comprises a value corresponding to the heater power setting.

11. The system according to claim 9, wherein:
the user input comprises a selection of a heater power setting from a plurality of preset heater power settings.

12. The system according to claim 9, wherein:
the user input comprises the selection from a plurality of heater power settings, the plurality of heater power settings comprising an upper limit corresponding to a maximum selectable heater power setting, a lower limit corresponding to a minimum selectable heater power setting, and one or more intermediate heater power settings.

13. The system according to claim 12, wherein:
the selection from the plurality of heater power settings is a positioning of a power selection slider presented at the user device.

14. The system according to claim 9, wherein;
the user device is configured to transmit the indication of the heater power setting by writing a value representative of the heater power setting to the non-combustible aerosol provision system over a Bluetooth connection between the user device and the non-combustible aerosol provision system.

15. The system according to claim 9, wherein:
the non-combustible aerosol provision system is further configured to communicate an existing power consumption state of the non-combustible aerosol provision system to the user device;
the user device is configured to control available heater power settings based on the existing power consumption state of the non-combustible aerosol provision system; and
the user device is configured to receive the user input by receiving a selected heater power setting of the available heater power settings.

16. The system according to claim 15, wherein when the existing power consumption state is a power saving mode, the user device is configured to restrict the available heater power settings to one or more low heater power settings lower than a maximum heater power setting available when the existing power consumption state is a power consumption state other than the power saving mode.

17. A non-transitory computer-readable medium comprising instructions which, when executed by processing circuitry of a computing device, cause the computing device to:
receive user input indicative of a heater power setting; and
transmit, to a non-combustible aerosol provision system, an indication of the heater power setting, wherein transmitting the indication of the heater power setting causes the non-combustible aerosol provision system to set a power level of a heater to the indicated heater power setting.

18. The non-transitory computer-readable medium according to claim 17, wherein the user input comprises a value corresponding to the heater power setting.

19. The non-transitory computer-readable medium according to claim 17, wherein the user input comprises a selection of the heater power setting from a plurality of preset heater power settings.

20. The non-transitory computer-readable medium according to claim 17, wherein the user input comprises a selection from a plurality of heater power settings, the plurality of heater power settings comprising an upper limit corresponding to a maximum selectable heater power setting, a lower limit corresponding to a minimum selectable heater power setting, and one or more intermediate heater power settings.

21. The non-transitory computer-readable medium according to claim 20, wherein the selection from the plurality of heater power settings is a positioning of a power selection slider presented at the user device.

22. The non-transitory computer-readable medium according to claim 17, wherein, to transmit the indication of the heater power setting, the instructions cause the computing device to write a value representative of the heater power setting to the non-combustible aerosol provision system over a Bluetooth connection between the user device and the non-combustible aerosol provision system.

23. The non-transitory computer-readable medium according to claim 17, wherein the instructions further cause the computing device to:
receive, from the non-combustible aerosol provision system, an existing power consumption state of the non-combustible aerosol provision system to the user device;
control available heater power settings based on the existing power consumption state of the non-combustible aerosol provision system; and
receive the user input by receiving a selected heater power setting of the available heater power settings.

24. The non-transitory computer-readable medium according to claim 23, wherein, when the existing power consumption state is a power saving mode, the instructions cause the computing device to restrict the available power settings to one or more low heater power settings lower than a maximum heater power settings available when the existing power consumption state is a power consumption state other than the power saving mode.
